(19) United States
(12) Patent Application Publication
(10) Pub. No.: US 2005/0018014 A1
(43) Pub. Date: Jan. 27, 2005

(54) Ink cartridge

(75) Inventors: Rene Butty, Hinwil (CH); Joachim Kretschmer, Ruti (CH); Markus Moser, Bertschikon (CH); Daniel Sulser, Wald (CH)

Correspondence Address: BURNS DOANE SWECKER & MATHIS L L P, POST OFFICE BOX 1404, ALEXANDRIA, VA, 22313-1404, US

(73) Assignee: Pelikan Hardcopy Production AG

(21) Appl. No.: 10/854,328

(22) Filed: May 27, 2004

(30) Foreign Application Priority Data
May 27, 2003 (DE) 10324059.4

(51) Int. Cl. B41J 2/14

(52) U.S. Cl. 347/49

(57) ABSTRACT

An ink cartridge is disclosed for insertion into a cartridge receptacle of an inkjet printer. The ink cartridge, on one side wall, has a locking snap member, which protrudes from the side wall and on which a detent edge is embodied, with which the locking snap member can be locked to a locking opening, provided on the cartridge receptacle, in its locking position for locking the ink cartridge in the cartridge receptacle. The locking snap member has a hinged portion, which with its pivot axis extends approximately parallel to the introduction plane (E) of the ink cartridge, in which the ink cartridge is to be inserted into the cartridge receptacle. The hinged portion is adjoined by a detent portion, on which a detent edge extending transversely to the introduction plane (E) is embodied.

### RELATED APPLICATIONS

This application claims priority under 35 U.S.C. §119 to a German Application 10324059.4 filed in Germany on 27 May 2003, the entire contents of which are hereby incorporated by reference in their entirety.

### BACKGROUND

The invention relates to an ink cartridge for insertion into a cartridge receptacle of an inkjet printer.

Replaceable ink cartridges of the type defined at the outset are well known and are used to supply ink to inkjet printers. For this purpose, typically at least one ink chamber is provided in the ink cartridge, and the liquid ink to be delivered to the ink printing head is stored in this chamber. The chambers of an ink cartridge can be fluid-mechanically separated from one another, each with their own ink supply openings, or can communicate fluidically with one another, with common ink supply and ink withdrawal openings. Ink chambers that are fluid-mechanically separated are used particularly in ink cartridges for color inkjet printers, for receiving the various colored inks. Ink cartridges with only a single ink chamber or with ink chambers communicating fluid-mechanically with one another are used in both monochrome inkjet printers and color inkjet printers. Particularly in color inkjet printers, however, both types of cartridge can be used together; for instance, one separate cartridge is provided for black ink and another separate cartridge, for instance with three chambers, each for one colored ink, is provided, or both the black ink and three different colored inks, for instance, are each provided in their own cartridge with one or more fluid-mechanically communicating ink chambers. For operating the inkjet printer, one or more ink cartridges are inserted into the cartridge receptacle of the printer; this receptacle is provided either so that it moves past the print head or is stationary in the housing of the inkjet printer. Upon insertion of the ink cartridge, the ink withdrawal opening, or every ink withdrawal opening, or the connection neck or every connection neck and the ink chamber or every ink chamber communicate fluid-mechanically with the corresponding supply connection in the cartridge receptacle.

For a functionally reliable ink supply, it is necessary for the connection neck, or every connection neck, of the ink cartridge to be coupled properly, that is, in airtight fashion, with the supply connection, or every supply connection, of the printer. This is attained by providing that the ink cartridge is retained in a predetermined, defined installed position in the cartridge receptacle and is preferably locked in this cartridge receptacle.

An ink cartridge that can be locked in a cartridge receptacle is known for instance from European Patent Disclosure EP 0 879 703, in which a locking device with which the ink cartridge can be locked in the cartridge receptacle is provided on the outside of a side wall of the ink cartridge housing, which wall is immediately adjacent to the underside of the housing on which the connection neck is provided. In this known ink cartridge, the locking device is embodied in the form of a support element protruding from the side wall, and a pawl is integrally formed onto the outside, remote from the side wall, of the support element. At its transition to the side wall, the support element is embodied elastically such that it can be pivoted back and forth relative to the side wall about a pivot axis. The pivot axis extends transversely to the introduction plane or pivoting plane of the ink cartridge, in which the ink cartridge necessarily moves upon insertion into the cartridge receptacle.

A disadvantage of the locking device of this known ink cartridge is that the support element must be embodied as a comparatively long lever, so that the pawl can snap properly into the locking opening provided in the cartridge receptacle. As a consequence, however, because of the material elasticity required for deflecting the support element about the pivot axis, the support element has only limited rigidity over the course of its length. The low material rigidity, however, means in the least favorable case that the pawl will not snap properly into the locking opening, since the support element springs back and deflects, as various experiments have shown. Improper insertion of the ink cartridge into the cartridge receptacle means that air can reach the print head via the ink supply, and this causes nozzle failures that in turn become visible as flaws in the printed image.

In the event of severe mechanical stress or if ink cartridges are dropped while being shipped, it has also been observed that the support element breaks off, making the ink cartridges in general unusable.

It has also been found that the ink cartridge is securely retained in the cartridge receptacle in only one direction, namely the prestressing direction of the support element, but can deflect laterally, so that leaks occur again and again at the transition between the connection neck and the supply connection.

### SUMMARY

It is the object of the invention to refine an ink cartridge of the type defined at the outset in such a way that proper insertion of the ink cartridge into the cartridge receptacle of the printer, with a defined, secure hold of the ink cartridge in the cartridge receptacle, and thus the avoidance of the entry of air into the ink supply between the connection neck, or each connection neck of the ink cartridge and the supply connection, or each supply connection, of the printer are assured.

In a first aspect of the invention, the ink cartridge of the invention has a locking snap member, which is pivotable about a pivot axis that extends approximately parallel to the introduction plane of the ink cartridge. For this purpose, the hinged portion of the locking snap member extends approximately parallel to the introduction plane. The actual detent edge, which is provided on the detent portion that adjoins the hinged portion, conversely extends transversely to the introduction plane of the ink cartridge, in order to assure proper locking between the ink cartridge and the cartridge receptacle.

By the disposition of the pivot axis parallel to the introduction plane, it is attained that upon insertion of the ink cartridge, the detent portion, with its outer edge, comes into contact with the upper edge of the cartridge receptacle only at some points, while in locking devices of the prior art this contact area is either two-dimensional or at least linear. Upon insertion of the ink cartridge, the locking snap member is moved out of its resting position. In contrast to the prior art, the locking device of the invention makes it easier to insert the ink cartridge into the cartridge receptacle, because of the lesser frictional forces. In the final phase of the insertion motion of the ink cartridge, the detent edge finally snaps into the locking opening, as a result of which the ink cartridge is secured in the cartridge receptacle.

By means of the pivot axis, about which the locking snap member is deflected and which extends parallel to the introduction plane of the ink cartridge, it is attained that the ink cartridge is fastened in the longitudinal direction of the ink cartridge, that is, the direction perpendicular to the side wall, by the prestressing force with which the locking snap member rests on the inside of the cartridge receptacle. At the same time, the locking snap member produces a torque, acting around the connection neck, by which the ink cartridge is additionally fastened in the cartridge receptacle in a direction deviating from the operative direction of the prestressing force; as a result, compared to the prior art, an improved and more-secure hold of the ink cartridge in the cartridge receptacle is attained, and in particular the risk of the entry of air into the ink supply is reduced.

Furthermore, by the deflection of the locking snap member about the pivot axis extending parallel to the introduction plane, it is attained that even the space required for the deflection of the locking snap member in the cartridge receptacle is substantially less, compared to the prior art. Because the overall effective lever arm length is less, which is determined by the point of contact with the cartridge receptacle of the lower, curving side edge of the detent portion of the locking device of the invention, it is furthermore attained that the spring force of the locking snap member, or positioning force that is operative upon insertion of the ink cartridge depends substantially less on the intrinsic elasticity of the plastic used than is the case in the prior art. Thus the locking device of the invention is also distinguished by exactly definable positioning forces, which furthermore can be purposefully set by the choice of the geometry of the side edges of the detent portion. By means of the suitable choice of the side edge geometry, the course of the positioning force can be set to be progressive, degressive, virtually constant, continuous, and/or graduated. The fact that the positioning force can be set exactly is a substantial advantage of the invention over the prior art. Moreover, compared to the prior art, the locking snap member can be embodied as quite narrow, so that the ink cartridge can likewise be embodied as narrow in its width crosswise to the introduction plane. While in EP 0 879 703, the minimum possible width of the ink cartridge cannot be less than the width of the support element, an ink cartridge having the locking device of the invention is not subject to this restriction. A further substantial advantage of the ink cartridge of the invention is that, unlike the prior art, the hinged portion of the locking snap member, in its maximum length, is not limited to the relatively slight width of the ink cartridge; instead, its length can be specified freely, at maximum up to the relatively great height of the ink cartridge. The spring constant and bending strength, or service life, of the hinged portion can also be set in a purposeful way. In particular, in the case of refillable ink cartridges, the risk of breakage of a hinge is thus maximally precluded. Furthermore, by means of a greater length of the hinged portion, fluctuations or errors in production, such as discontinuities of material or bubbles, in this region can be compensated for, which advantageously affects the production costs.

It has furthermore been demonstrated in experiments that with the ink cartridge of the invention, a clearly perceptible clicking can be heard as soon as the detent edge comes into engagement with the locking opening provided on the cartridge receptacle, so that the user receives an acoustical signal once the ink cartridge has been properly inserted into the cartridge receptacle.

Even the production of the ink cartridge of the invention is markedly simplified, compared to the prior art as described for instance in EP 0 879 703, since the locking device has no undercuts whatever that could make it more difficult to unmold the ink cartridge of the invention in the injection molding process.

Further advantages of the invention will become apparent from the ensuing description, the dependent claims, and the drawings.

For instance, in an especially preferred embodiment of the ink cartridge of the invention, it is proposed that the detent portion be designed such that, viewed in a plane transverse to the longitudinal direction of the hinged portion, it extends in angled fashion relative to the introduction plane, by a predetermined angle. As a result, it is assured at every instant in the insertion motion of the ink cartridge that the detent portion will come into contact with the upper edge of the cartridge receptacle only at some points. It has been demonstrated in experiments that especially good results can be obtained if the detent portion extends at an angle in a range of from 25° to 35° to the introduction plane.

It is furthermore proposed, in a preferred refinement of the ink cartridge of the invention, that the side edge, pointing in the direction of the underside of the ink cartridge housing, of the detent portion be designed such that it extends in curved fashion and merges with the detent edge. Thus it has been demonstrated that as a result of the curved course of the side edge, the torques operative upon deflection, and thus the forces counteracting the insertion motion of the ink cartridge, can be varied in a purposeful way. The removal of the ink cartridge from the cartridge receptacle is advantageously reinforced by the curved course of the side edge and by the spring action of the locking snap member.

The curved course of the side edge, before it merges with the detent edge, can also, however, merge with a straight portion extending parallel to the introduction plane.

The detent portion and the hinged portion are preferably made from the same material, and viewed in a plane transverse to the longitudinal direction of the hinged portion, the detent portion has approximately twice to three times greater a material thickness than the hinged portion. As a result, the elasticity of the locking snap member can be predetermined very exactly, so that if at all possible the locking snap member deforms elastically only in the hinged portion, while the detent portion is comparatively rigid.

For the sake of unproblematic removal of the ink cartridge from the cartridge receptacle, in a preferred refinement of the ink cartridge of the invention an actuating element is formed integrally onto the outside, remote from the side wall of the housing, of the detent portion, spaced apart from the hinged portion.

In a further preferred refinement of the ink cartridge of the invention, means are provided, preferably on the side wall of the housing, that limit a deflectability of the locking snap member. In this way, a mechanical overload and hence breaking off of the locking snap member are prevented.

In order to retain even ink cartridges of relatively great width securely in the cartridge receptacle, it is furthermore proposed that two mirror-symmetrical locking snap members be provided on the side wall of the ink cartridge; an especially secure hold of a large ink cartridge, for instance a multi-color cartridge, in the cartridge receptacle can be attained as a result. Instead of a mirror-symmetrical disposition of the hinged portions, these portions may also be embodied parallel on the side wall of the ink cartridge. While in the mirror-symmetrical arrangement, prestressing forces that are operative in different directions result and thus assure the secure hold of the ink cartridge in the cartridge receptacle, the parallel disposition creates a resultant torque which in accordance with the disposition with a locking snap member advantageously reinforces the secure hold of the ink cartridge in the cartridge receptacle by bracing the ink cartridge against a guide face of the cartridge receptacle.

In a second aspect, the invention pertains to an ink cartridge wherein the locking snap member has a tilt lever that is L-shaped in longitudinal section, with a detent portion and an actuation portion protruding approximately at right angles from the detent portion. The tilt lever is pivotably connected to the side wall of the housing by a film hinge in such a way that upon insertion of the ink cartridge into the cartridge receptacle, the tilt lever pivots automatically into its locking position, in which the actuation portion extends approximately parallel to the side wall of the housing or rests on it, while the detent portion is in engagement with the locking opening on the cartridge receptacle. The flanks of the tilt lever are designed such that the tilt lever remains in its locking position without external force being exerted, and does not come loose again until the tilt lever, with the aid of the actuation portion, is pressed back into the release position, as a result of which the ink cartridge snaps out of its locking position. In this ink cartridge of the invention as well, a secure hold of the ink cartridge in the cartridge receptacle is assured. Also in this embodiment, means are provided, preferably on the side wall of the housing, that limit a deflectability of the locking snap member in order to prevent mechanical overloading and the breaking off of the locking device.

In a third aspect, the invention relates to an ink cartridge wherein the locking device has a locking element embodied separately from the housing and detent element that is to be actuated separately from the locking element. At least the locking element is held displaceably in a receptacle, embodied on the side wall of the housing, between a release or unlocking position, in which the ink cartridge can be removed from the cartridge receptacle, and a locking position, in which the locking element keeps the detent element in engagement with the locking opening in the cartridge receptacle.

In an especially preferred refinement of this ink cartridge of the invention, a substantially hollow-cylindrical receptacle is formed integrally perpendicularly onto the side wall of the housing and is closed by it toward the housing; a ball is provided as a detent element in the receptacle and is prestressed into the locking position by a compression spring, as a locking element, disposed between the ball and the side wall. The opening of the receptacle is designed such that while the ball does protrude partway out of the receptacle, it is nevertheless not forced out of the receptacle by the compression spring. In this locking device, the ink cartridge need merely be inserted into the cartridge receptacle; the ball is first pressed into the receptacle, and when the final installed position of the ink cartridge is reached, it snaps into the locking opening. For removal of the ink cartridge from the cartridge receptacle, the ink cartridge need merely be removed from the cartridge receptacle counter to the force of the compression spring.

In an alternative refinement of the ink cartridge the receptacle can be embodied as a pivot bearing, by means of which the locking element is pivotably supported about a pivot axis extending transversely to an introduction plane of the ink cartridge, in which plane the ink cartridge is to be inserted into the cartridge receptacle. A pawl is embodied as a detent element on the outside, remote from the side wall, of the locking element. In this refinement, the advantage is that for different types of printer the ink cartridge can be inserted simply by replacing the locking element, as long as the connection neck is embodied accordingly. The locking element is preferably shaped such that once the ink cartridge has been inserted into the cartridge receptacle of the inkjet printer, it pivots automatically by gravity into the locking position; that is, the locking position represents a stable position of equilibrium of the pivotably supported locking element. The necessity of using springs or elastic materials is thus eliminated.

In the refinement of the ink cartridge of the invention described above, two bearing blocks integrally formed onto the side wall preferably serve as pivot bearings, while the locking element has an actuating lever with two laterally protruding bearing journals, with which the actuating lever is pivotably supported in the bearing blocks. On the free end of the actuating lever, pointing toward or away from the side wall, depending on the locking opening embodied in the cartridge receptacle, a pawl is provided as the detent element. Alternatively, it is proposed that as the pivot bearing, a hinge strip that merges flush with the cap of the ink cartridge and protrudes past the side wall be used, while the locking element is embodied as a rocker, and the rocker has an actuating lever, which in the locking position rests on the top side or cap of the ink cartridge and merges with an angled bearing portion with which the rocker is slipped onto the hinge strip for the sake of rotatable bearing action. The bearing portion is adjoined by a detent lever extending approximately perpendicular to the actuating lever, and on the free end of this lever, a pawl, as the detent element, protrudes toward the side wall or away from it, depending on the locking opening embodied in the cartridge receptacle.

In a further preferred refinement of the ink cartridge of the invention, the receptacle is embodied as a pivot bearing, on which the locking element, embodied as a cylindrical rotary locking bar, is rotatably supported about an axis of rotation that extends approximately parallel to the introduction plane of the ink cartridge, in which plane the ink cartridge is to be inserted into the cartridge receptacle. As the detent element, a spirally extending detent edge is embodied on the jacket face of the cylindrical rotary locking bar, and after the insertion of the ink cartridge, by rotation of the rotary locking bar about the axis of rotation, this detent edge can be brought into or out of engagement with the locking opening in the cartridge receptacle. Because of the spiral course of the detent edge, upon rotation of the rotary locking bar the ink cartridge is drawn into its final installed position and in this way secured in the cartridge receptacle. For removal of the cartridge, the rotary locking bar need merely be rotated back into its outset position.

Moreover, in an alternative refinement of the ink cartridge of the invention, it is proposed that a channel be provided on the side wall, as a receptacle, which on its side remote from the side wall has an opening into which a detent hook, embodied integrally with the channel wall, protrudes; in its unlocking position, this detent hook protrudes with its back side into the channel, and on its front side remote from the channel, it has a pawl as the detent element. For adjusting the pawl, a wedge is introduced into the channel as a locking element, with which the detent hook is movable into its locking position, in which the pawl is in engagement with the locking opening in the cartridge receptacle. For removing the ink cartridge from the cartridge receptacle, the wedge need merely be pulled out of the channel.

In a refinement of the ink cartridge of the invention, it is furthermore proposed that as the receptacle, a pocket be embodied in the side wall of the ink cartridge; this pocket is optionally partly closed on its face end pointing in the direction of the top side or cap of the ink cartridge and on its open side, opposite the side wall of the ink cartridge. As the locking element, an elastic snap member that is substantially U-shaped in cross section is introduced into the pocket; this snap member has at least a first leg for bracing against the side wall of the ink cartridge and at least a second leg on whose free end a detent edge, as a detent element, is embodied on the side pointing away from the side wall of the ink cartridge. As soon as the ink cartridge is inserted into the cartridge receptacle, the U-shaped snap member is introduced into the pocket and is braced with at least a first leg against the side wall, while the at least second leg, with its detent edge, comes into engagement with the locking opening in the cartridge receptacle. For removing the ink cartridge from the cartridge receptacle, the U-shaped snap member need merely be compressed enough that the detent edge is out of engagement with the locking opening. Next, the snap member is first pulled out of the pocket, and then the ink cartridge is pulled out of the cartridge receptacle. In the event that the pocket is embodied as partly closed on its side opposite the side wall of the ink cartridge, the U-shaped snap member can also be provided displaceably in the pocket, so that when the ink cartridge is removed from the cartridge receptacle, the snap member remains in the pocket.

To enable the ink cartridge of the invention to be positioned even more precisely in the cartridge receptacle, in all the ink cartridges of the invention described above it is preferably proposed that a positioning aid be embodied on an opposite side wall of the ink cartridge, which is remote from the side wall of the ink cartridge on which the locking device is provided; upon insertion of the ink cartridge into the cartridge receptacle, this positioning aid can be introduced into a positioning opening provided on the cartridge receptacle. With the aid of this positioning aid, which can for instance be embodied in the form of a positioning peg or a positioning edge, it is possible for the ink cartridge to be guided in a defined way already upon insertion into the cartridge receptacle.

For this purpose, it is furthermore proposed that on the underside of the ink cartridge, a protruding positioning peg be provided, which upon insertion of the ink cartridge into the cartridge receptacle can be introduced into a positioning opening provided in the cartridge receptacle.

It is also proposed that at least one positioning aid, preferably a positioning edge or an elastic element, be provided on the connection neck of the ink cartridge, which aid upon insertion of the ink cartridge into the cartridge receptacle can be brought into engagement with the supply connection of the inkjet printer for positioning purposes.

### BRIEF DESCRIPTION OF THE DRAWINGS

The invention will be described in further detail below in terms of eight exemplary embodiments, in conjunction with the accompanying drawing. In the drawing:

FIG. 1 shows a side view of a first exemplary embodiment of an ink cartridge of the invention, with a locking snap member for locking the ink cartridge in a cartridge receptacle of an inkjet printer, with the cap of the ink cartridge not shown;

FIG. 2 is a plan view on the ink cartridge of FIG. 1;

FIG. 3 is a front elevation view of the ink cartridge of FIG. 1;

FIG. 4 is a perspective view of the ink cartridge of FIG. 1;

FIG. 5 is a plan view on a preferred version of the ink cartridge of FIG. 1;

FIG. 6 is a fragmentary perspective view of a second exemplary embodiment of an ink cartridge of the invention, with a tilt lever as the locking device, with only the locking device and part of the housing of the ink cartridge being shown;

FIG. 7 is a fragmentary perspective view of a preferred feature of the second exemplary embodiment;

FIG. 8 is a fragmentary perspective view of a third exemplary embodiment of an ink cartridge of the invention, with a ball, prestressed in a receptacle, as the locking device;

FIG. 9 is a fragmentary perspective view of a fourth exemplary embodiment of an ink cartridge of the invention, with a rotary locking bar as the locking device;

FIG. 10 is a fragmentary perspective view of a fifth exemplary embodiment of an ink cartridge of the invention, with a detent hook, integrally formed onto a partly open channel, as the locking device, which can be actuated by a wedge to be introduced into the channel;

FIG. 11 is a fragmentary perspective view of a sixth exemplary embodiment of an ink cartridge of the invention, with a U-shaped locking element, to be inserted into a receptacle on the housing, as the locking device;

FIG. 12 is a fragmentary perspective view of a modification of the ink cartridge of FIG. 11, in which the pocket side, opposite the side wall of the ink cartridge, is embodied as only partly open;

FIG. 13 is a fragmentary perspective view of a seventh exemplary embodiment of an ink cartridge of the invention, with a rocker, supported pivotably on the housing, as the locking device;

FIG. 14 is a fragmentary perspective view of an eighth exemplary embodiment of an ink cartridge of the invention, with an L-shaped rocker as the locking device, which is supported pivotably near the top side of the housing.

### DETAILED DESCRIPTION

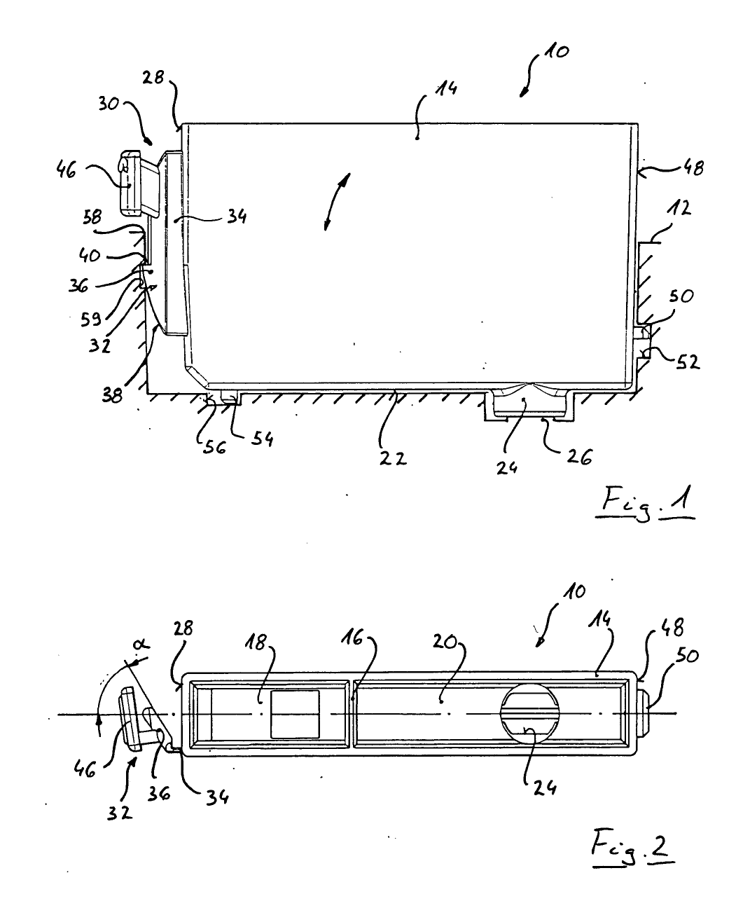

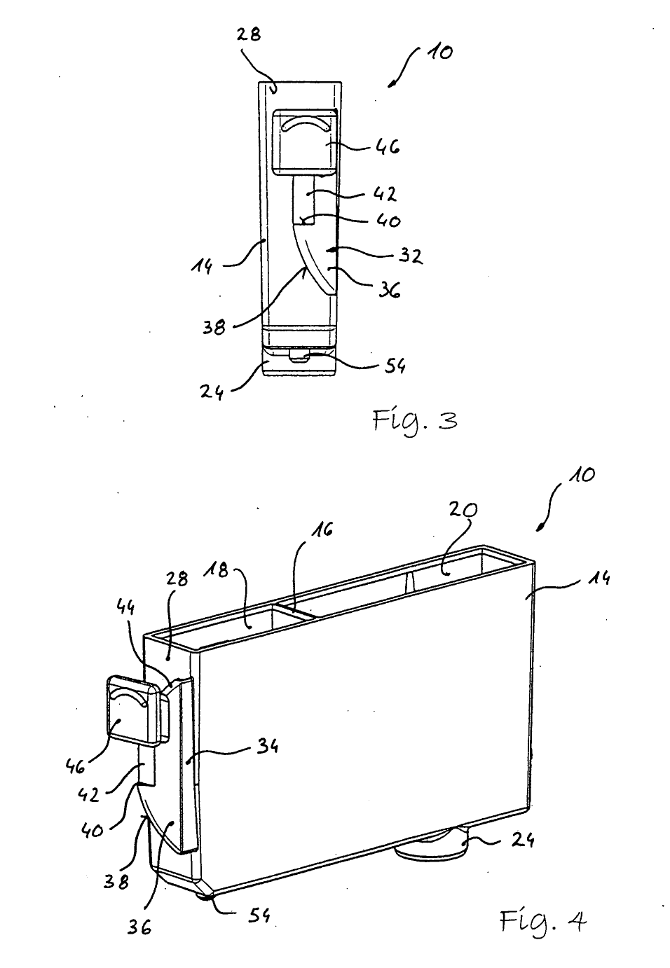

FIGS. 1 through 4 show a first exemplary embodiment of an ink cartridge 10 of the invention, which can be inserted into a cartridge receptacle 12 of an inkjet printer; the cartridge receptacle 12 is provided in a known manner either directly on the print head or remote from the print head in the printer housing. For the sake of simplicity, the cap of the ink cartridge 10 has not been shown.

The ink cartridge 10 has a housing 14, made from plastic, which is divided, as FIGS. 2 and 4 particularly show, by a partition 16 into an ink chamber 18 (shown on the left in FIG. 2) and a storage chamber 20 fluidically communicating with the ink chamber 18. A capillary ink reservoir, not further shown, such as a porous sponge or a nonwoven material, in which the liquid ink is stored, is typically received in the storage chamber 20.

The storage chamber 20 communicates fluidically with a connection neck 24, embodied on the underside 20 of the housing 14, that when the ink cartridge 10 has been properly inserted into the cartridge receptacle 12 of the inkjet printer is coupled with a supply connection 26 of the inkjet printer, so that ink is supplied to the print head from the ink cartridge 10 as needed.

To assure proper supplying of ink from the ink cartridge 10 into the inkjet printer, the ink cartridge 10 must be located in a defined position in the cartridge receptacle 12 and secured therein. To assure a proper, defined hold of the ink cartridge 10 of the invention in the cartridge receptacle 12, the ink cartridge 10 for this purpose, on its side wall 28 shown on the left in FIGS. 1 and 2, has a locking device 30, whose structure will be explained in detail below.

Serving as the locking device 30 is a locking snap member 32, which has a hinged portion 34 that is integral with the side wall 28 and protrudes approximately perpendicular from the side wall 28 of the housing 14. The hinged portion 34 extends at least approximately perpendicularly to the underside 22 of the housing 14 and thus at least approximately parallel to an introduction plane E (see FIG. 2), in which the ink cartridge 10 is pivoted or pressed (see the arrow in FIG. 1) into its installed position in the cartridge receptacle 12, as will be described in further detail hereinafter.

The hinged portion 34 is adjoined by a detent portion 36, which compared with the hinged portion 34 has approximately twice to three times greater a material thickness. The detent portion 36 likewise extends approximately perpendicularly with respect to the underside 22 of the housing 14, but relative to the side wall 28 it is angled by a predetermined angle of approximately 25° to 35°, resulting in an angle α of approximately 65° to 55° with respect to the introduction plane E.

The side edge 38, pointing in the direction of the underside 22 of the housing 14, of the detent portion 36 has a curved course and ends in a detent edge 40, which extends transversely to the introduction plane E, and which is embodied on the detent portion 36 by providing that part of the detent portion 36 has been recessed in the shaping process and a face 42 extending approximately parallel to the side wall 28 has been formed.

Near the upper side edge 44 of the detent portion 36, spaced apart from the face 42, an approximately rectangular actuating element 46 is integrally formed on, with which the detent portion 36 can be deflected by hand, counter to a prestressing force caused by the elasticity of the material making up the hinged portion 34.

Near the underside 22 of the housing 14, a positioning aid in the form of a positioning edge 50 is embodied on the opposite side wall 48, remote from the side wall 28. With the aid of this positioning edge 50, the insertion of the ink cartridge 10 into the cartridge receptacle 12 can be facilitated. To that end, on the cartridge receptacle 12, an appropriate receiving opening 52 is provided, into which the positioning edge 50 can be introduced by insertion of the ink cartridge 10. Thus this positioning edge 50 forms the pivot point of the insertion motion of the ink cartridge 10 into the cartridge receptacle 12.

If the ink cartridge 10 is now inserted into the cartridge receptacle 12, the user can first orient the ink cartridge 10 relatively in the cartridge receptacle 12, either with the aid of the positioning edge 50 or the positioning aids provided on the connection neck. Next, the user pivots the ink cartridge 10 in the introduction plane E downward, as represented by the arrow in FIG. 1, whereupon the locking snap member 32, with its curving side edge 38, comes into contact with an upper edge 58 of the cartridge receptacle 12, and as the insertion motion increases, the locking snap member 32 is moved out of its resting position shown in FIGS. 1 through 4. Because of the oblique position of the side edge 38 relative to its counterpart in the cartridge receptacle 12, it is attained that the locking snap member 32 comes into contact with the edge 58 of the cartridge receptacle 12 only at some points, which because of the lesser frictional forces facilitates the insertion of the ink cartridge 10 into the cartridge receptacle 12. The positioning force required upon insertion of the ink cartridge 10 into the cartridge receptacle 12 is kept virtually constant until the locking position is reached, because of the curved embodiment of the side edge 38.

In the final phase of the introduction motion of the ink cartridge 10, the detent edge 36 finally snaps into the locking opening 59, as a result of which the ink cartridge 10 is secured in the cartridge receptacle 12. In the process, by means of the pivot axis, which extends parallel to the introduction plane E of the ink cartridge 10 and about which the locking snap member 32 is deflected, it is attained that the ink cartridge 10 is fastened in the longitudinal direction of the ink cartridge 10, that is, in the direction perpendicular to the side wall 38, by the prestressing force with which the locking snap member 32 rests on the inside of the cartridge receptacle 12. At the same time, the locking snap member 32 exerts a torque, acting about the connection neck 24, by which the ink cartridge 10 is additionally braced against the cartridge receptacle 12.

Furthermore, by the deflection of the locking snap member 32 about the axis extending parallel to the introduction plane E, it is attained that the forces required for deflecting the locking snap member 32 are relatively slight. Thus compared with the spacing provided in comparable locking devices in the ink cartridges known from the prior art, the spacing between the point at which the cartridge receptacle 12 touches the locking snap member 32 is markedly less, so that consequently the torque required to deflect the locking snap member 32 is also markedly less.

Moreover, by suitable design of the curved course of the side edge 38, the torque operative upon the deflection and thus the force counteracting the introduction motion of the ink cartridge 10 can be varied in a purposeful way. Because of the lesser spacing between the contact point between the edge of the cartridge receptacle 12 and the curving side edge 38 and the pivot axis extending through the hinged portion 34, it is furthermore attained that because the spacing is only slight, the intrinsic elasticity of the material from which the locking snap member 32 is made plays at most a subordinate role for the forces operative upon the insertion, so that by this means as well, more-exact definition of the actually operative forces is possible.

Finally, it has been demonstrated in experiments that in the ink cartridge 10 of the invention a clearly perceptible clicking can be heard as soon as the detent edge 40 comes into engagement with the locking opening 59 provided on the cartridge receptacle 12, so that the user receives an acoustic report when the ink cartridge 10 has been properly inserted into the cartridge receptacle 12.

The production of the ink cartridge 10 of the invention is also simplified markedly, compared to the prior art, for instance as described in EP 0 879 703, since the locking device 32 has no undercuts whatever, making the ink cartridge 10 of the invention easier to unmold in plastic injection molding, and resulting in lower tool costs.

If the ink cartridge 10 is now to be removed from the cartridge receptacle 12, the locking snap member 32 need merely be moved briefly counter to the prestressing force, with the aid of the actuating element 46. As soon as the detent edge 40 is out of engagement with the locking opening 59, the ink cartridge 10 is pressed out of the cartridge receptacle 12 by means of the curved course of the side edge 38 and by means of the prestressing force with which the locking snap member 30 is prestressed.

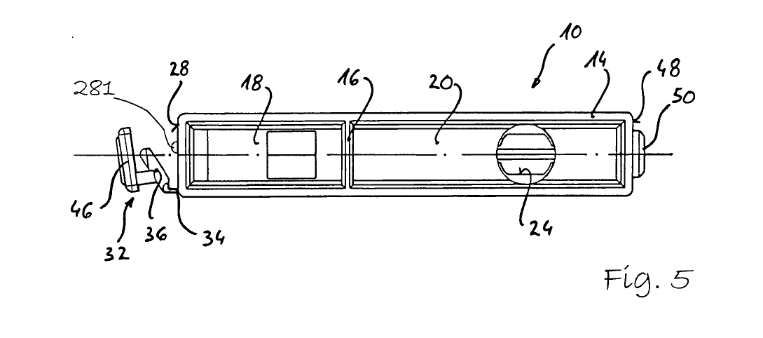

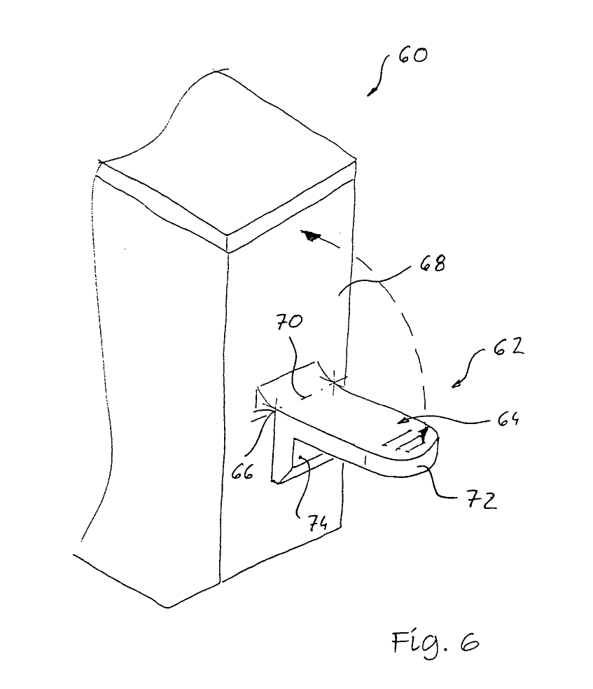

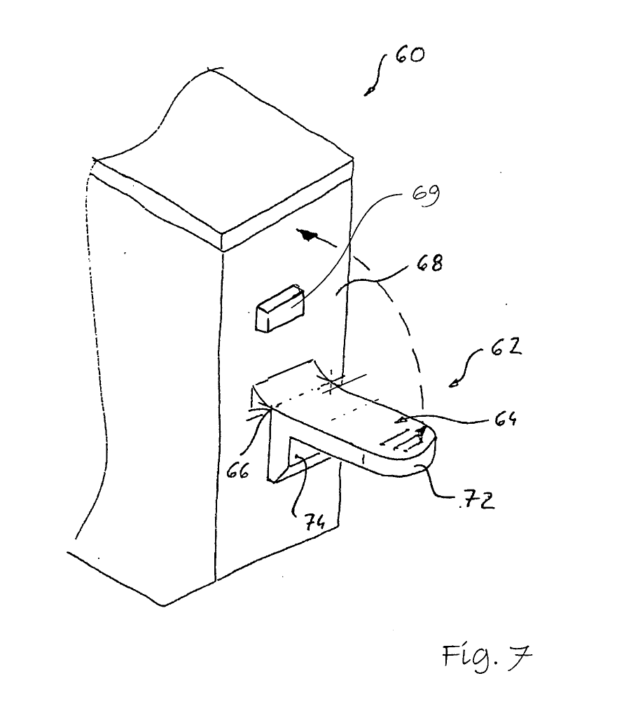

FIG. 5 shows a plan view on a preferred feature of the ink cartridge 10 of FIG. 1. On the side wall 28, a rib 29 is provided, which limits a deflectability of the locking snap member 32 toward the side wall. As a result, breaking off of the locking snap member 32, which can occur for instance from a mechanical overload on the hinged portion 34, is prevented. The rib 29 may be adhesively bonded to the side 28. However, it is especially advantageous for it to be formed integrally with the side wall 28. Instead of a rib 29, one or more bumps can advantageously be provided. The rib 29 or bumps can also advantageously be provided on the side of the locking snap member 32 toward the side wall 28, instead of on the side wall 28 itself.

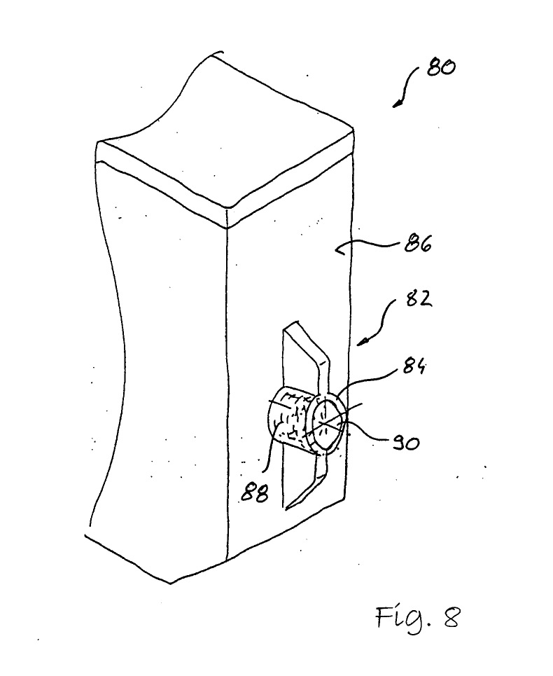

The versions of ink cartridges of the invention described below in conjunction with FIGS. 6 through 12 are ink cartridges which can be inserted into the cartridge receptacle 12 instead of the ink cartridge 10 described above, but showing the cartridge receptacle 12 in FIGS. 5 through 12 has been dispensed with.

Thus in FIG. 6, a second exemplary embodiment of an ink cartridge 60 of the invention is shown in a fragmentary perspective view. The structure of the ink cartridge 60 is essentially equivalent to the structure of the ink cartridge 10 and differs only in how the locking device 62 is embodied. Thus in this ink cartridge 60, as the locking device 62, a tilt lever 64 that is L-shaped in longitudinal section is used, which with its angled edge 66 closest to the side wall 68 is integrally formed onto this side wall by a film hinge 70. The pivot axis of the film hinge 70 extends transversely to the introduction plane E of the ink cartridge 60.

The tilt lever 64 has an actuation portion 72 as well as a detent portion 74 protruding perpendicularly from the actuation portion. In its resting position shown in FIG. 6, the tilt lever 64 extends approximately perpendicularly to the side wall 68, while the detent portion 74 extends approximately parallel to the side wall 68.

If the ink cartridge 60 is now inserted into the cartridge receptacle 12, the edge 58 of the cartridge receptacle 12 comes into contact with the underside of the actuation portion 72 and, as the introduction motion continues, slowly pivots the tilt lever 64 upward, as indicated by the arrow in FIG. 6. In the process, the detent portion 74 comes into engagement with the locking opening 59 embodied on the cartridge receptacle 12, so that the ink cartridge 60 is locked in the cartridge receptacle 12, as long as no external forces engage the actuation portion 72.

For releasing the ink cartridge 60, the actuation portion 72 need merely be pressed in the opposite direction, as a result of which the ink cartridge 60 is leveraged out of the cartridge receptacle 12.

FIG. 7 shows a preferred feature of the ink cartridge of FIG. 6. A projection 69 is formed onto the side wall 68 and limits the movability of the tilt lever 64 and thus of the locking device 62. This prevents the tilt lever 64 from breaking off in response to a mechanical overload.

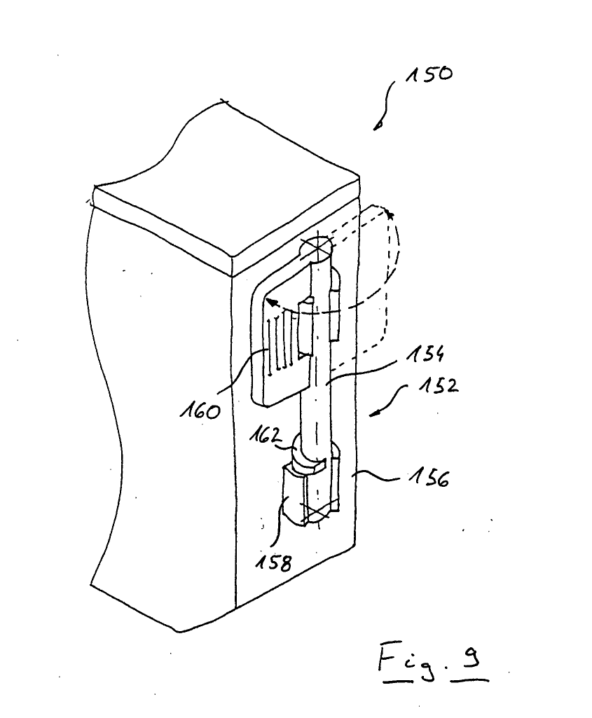

FIG. 8 shows a third exemplary embodiment of an ink cartridge 80 of the invention. The ink cartridge 80 likewise differs from the ink cartridge 10 in its locking device 82. In this case, the locking device 82 has an approximately hollow-cylindrical receptacle 84, which is formed onto the side wall 86 and closed on one side by it and is also braced by reinforcing ribs. A compression spring 88 (shown in dashed lines) is inserted into the receptacle 84; it is braced on the side wall 86 and rests with prestressing on a ball 90 that is likewise retained in the receptacle 84. The opening in the receptacle 84 is designed such that while the ball 90 does protrude partway out of the receptacle 84, it is not pressed out of it by the compression spring 88.

Upon insertion of the ink cartridge 80 into the cartridge receptacle 12, the ball 90 is pressed into the receptacle 84 counter to the force of the compression spring 88 and finally snaps into the locking opening 59 provided on the cartridge receptacle 12, thereby securing the ink cartridge 80 in the cartridge receptacle 12. For removal, the ink cartridge 80 need merely be pivoted out of the cartridge receptacle 12 counter to the force of the compression spring 88.

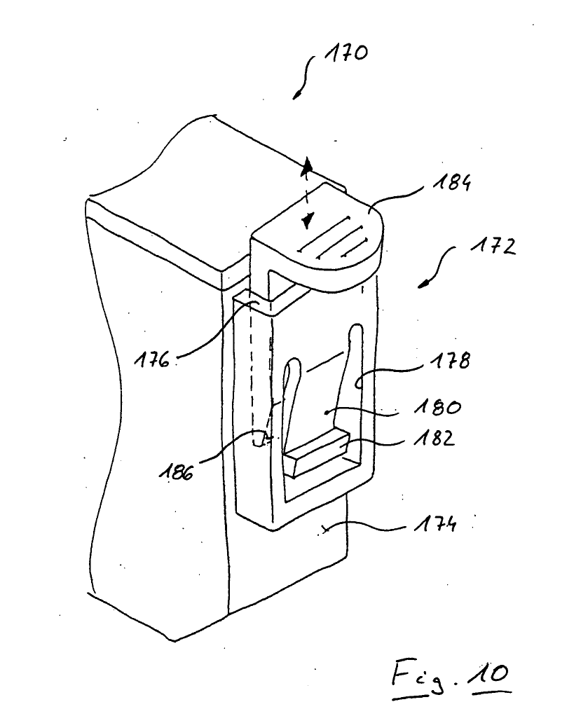

FIG. 9 shows a fourth exemplary embodiment for an ink cartridge 150 of the invention. The structure of the ink cartridge 150 again essentially corresponds to that of the ink cartridge 10 and differs from it only in the locking device 152 employed. The locking device 152 is embodied as a rotary locking bar 154, which is rotatable about an axis of rotation extending approximately parallel to the introduction plane E of the ink cartridge 150. To this end, the rotary locking bar 154 is rotatably supported in two bearing points 158 provided on the side wall 156 of the ink cartridge 150. The bearing points 158 are slit to make installation easier, so that the rotary locking bar 154 can be inserted into the bearing points 158 without problems.

On its end shown at the top in FIG. 9, a ribbed actuating element 160 protrudes radially outward; with it, the rotary locking bar 154 is rotatable, as indicated by the arrow in FIG. 9, between a release position or unlocking position and a locking position. Near the bearing point 158 shown at the bottom in FIG. 9, a detent edge 162 that extends helically around the shaft of the rotary locking bar 154 is provided.

For insertion of the ink cartridge 150, this cartridge is merely inserted into the cartridge receptacle 12 in the usual way and pressed into its installed position, in the course of which the rotary locking bar 154 is moved into the release position. Next, with the aid of the actuating element 160, the rotary locking bar 154 is rotated into its locking position, whereupon the detent edge 162 comes into engagement with the locking opening 59 provided on the cartridge receptacle 12. Because of the helical course of the detent edge 162, it is attained that the ink cartridge 150 moves into its final installed position and is secured in the cartridge receptacle 12.

For removal of the ink cartridge 150 from the cartridge receptacle 12, the rotary locking bar 154 need merely be rotated into its release position, that is, its unlocking position. The ink cartridge 150 can then be removed from the cartridge receptacle 12 without problems.

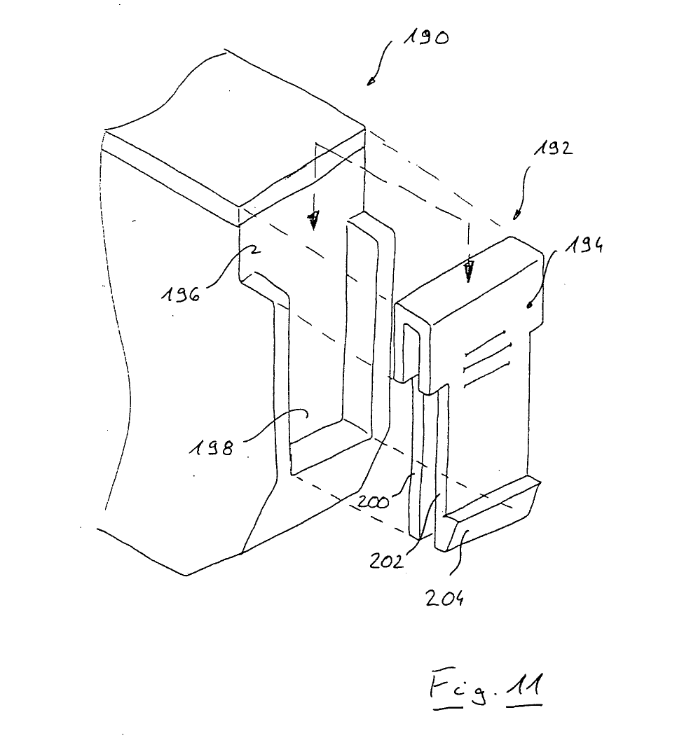

FIG. 10 shows a fifth exemplary embodiment of an ink cartridge 170, whose structure is substantially equivalent to that of the ink cartridge 10 and differs from it only in a locking device 172. In this exemplary embodiment, a channel 176 extending in the introduction plane E of the ink cartridge 170 and having a rectangular cross section is integrally formed onto the side wall 174, and on its outside remote from the ink cartridge 170, it has a rectangular opening 178. A detent hook 180, which is integrally formed onto the channel wall shown at the top in FIG. 10, protrudes into the opening 178, likewise extending parallel to the introduction plane E. The detent hook 180 is angled slightly and protrudes into the channel 176 far enough that the detent hook 180, with the front side of its pawl 182, extends approximately flush with the outside of the channel 176.

A wedge 184, which serves as an actuating element for the detent hook 180, can be introduced into the channel 176. If the ink cartridge 170 is now to be inserted into the cartridge receptacle 12, then the wedge 184 is first pulled out of the channel 176, so that the detent hook 180 moves into its release position, that is, its unlocking position. Next, the ink cartridge 170 is inserted into the cartridge receptacle 12. After that, the wedge 184 is introduced into the channel 176, whereupon the wedge face 186, represented by the dashed line, on the wedge 184 comes into contact with the inside of the detent hook 180 and presses the detent hook into the locking position, in which the detent hook 180, with its pawl 182, is in engagement with the locking opening 59 of the cartridge receptacle 12. For removing the ink cartridge 170, the wedge 184 need merely be pulled out of the channel 176, whereupon the detent hook 180 returns to its release position again.

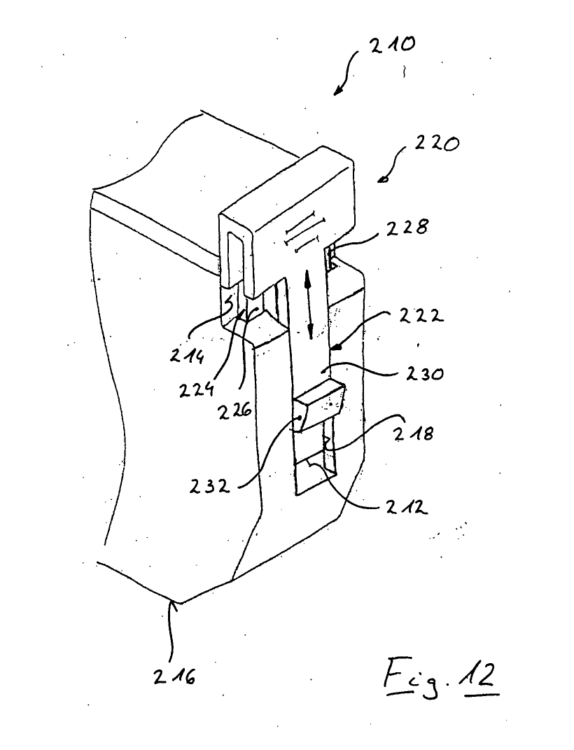

FIG. 11 shows a sixth exemplary embodiment of an ink cartridge 190 of the invention, whose structure likewise corresponds substantially to that of the ink cartridge 10 and differs from it only in the locking device 192. The locking device 192 has a U-shaped snap member 194, which can be inserted into a pocket 198 embodied in the side wall 196. For this purpose, the pocket 198 is open on its side shown at the top in FIG. 11, so that the snap member 194 can be introduced into the pocket 198.

The U-shaped snap member 194 has a first leg 200, shown partly concealed in FIG. 11, with which the snap member 194 is braced on the side wall 196 when the snap member 194 is inserted into the pocket 198. The second leg 202 serves as a detent element and for this purpose is provided with a detent edge 204 on its free end.

For installing the ink cartridge 190 shown into the cartridge receptacle 12, the ink cartridge is first inserted into the cartridge receptacle 12 without the snap member 194 and pressed into its final installed position by hand. Next, the U-shaped snap member 194 is introduced into the pocket 198, whereupon the second leg 202 is deflected in the direction of the first leg 200. When the detent edge 204 snaps into the locking opening 59 embodied on the cartridge receptacle 12, this locks the ink cartridge 190 in the cartridge receptacle 12. For releasing the ink cartridge 190, the U-shaped snap member need merely be compressed, near the transition between the two legs 200 and 202, so that the detent edge 204 is put out of engagement with the locking opening 59. Next, the snap member 194 can be pulled out of the pocket 198, and finally the ink cartridge 190 can be removed.

In FIG. 12, finally, an ink cartridge 210 is shown in a fragmentary perspective view; this is a modification of the ink cartridge 190 shown in FIG. 11. The ink cartridge 210 likewise has a pocket 212 on one of its side walls 214, but in this pocket, the side opposite the side wall 214 of the ink cartridge 210 is embodied as partly closed and has a guide recess 218 that extends in the direction of the underside 216 of the ink cartridge 210.

Acting as the locking device 220 is a U-shaped snap member 222, in which the first leg 224 is subdivided into two leg portions 226 and 228, which are shown only in part. The second leg 230 is adapted to the width of the guide recess 218 and is guided in it. On the free end of the second leg 230, as in the exemplary embodiment shown in FIG. 11, a detent edge 232 is embodied, with which the snap member 222 can be brought into engagement with the locking opening 59.

The U-shaped snap member 222 is guided in the pocket 212 with both of its leg portions 226 and 228 of the first leg 224, while the second leg 230 is guided in the guide recess 218; the detent edge 232 protrudes past the outside of the pocket 212 and is in its locking position.

After the insertion of the ink cartridge 210 into the cartridge receptacle 12, the ink cartridge 210 is initially kept in its installed position. Next, with its two leg portions 226 and 228 of the first leg 224, the snap member 222 is introduced into the pocket 212. Alternatively, the snap member 222 can already be partly introduced into the pocket 212 before the ink cartridge 210 is inserted. After that, the snap member 222 is pressed downward (see arrow in FIG. 12) into its locking position, whereupon the second leg 230 is deflected, by the detent edge 232 in contact with the inside of the cartridge receptacle 12, in the direction of the ink cartridge 210 until such time as the detent edge 232 comes into engagement with the locking opening 59.

To release the ink cartridge 210, the snap member 222 must be compressed, on its end protruding from the pocket 212, where the legs 224 and 230 merge with one another, and as a result the detent edge 232 is put out of engagement with the locking opening 59. Next, the snap member 222 is at least partly pulled out of the pocket 212, and the ink cartridge 212 is removed from the cartridge receptacle 12.

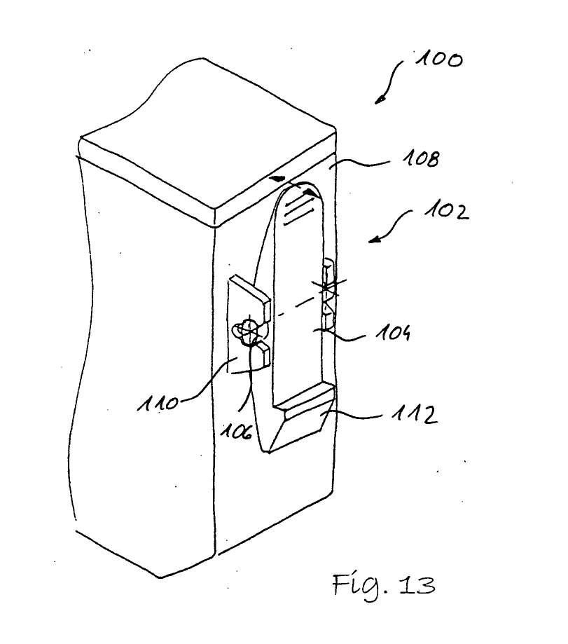

FIG. 13 shows a seventh exemplary embodiment of an ink cartridge 100 of the invention, whose structure likewise corresponds to that of the ink cartridge 10 and differs from it only in terms of the locking device 102 employed.

Thus the locking device 102 has an actuating lever 104, from both of whose long edges a respective bearing journal 106 protrudes. The actuating lever 104 is supported pivotably rotatably about a pivot axis extending transversely to the introduction plane E, with the bearing journals 106, in two bearing blocks 110 provided on the side wall 108 of the ink cartridge 100. On the free end of the actuating lever 104, on its outside remote from the side wall 108, a perpendicularly protruding pawl 112 is provided, the pawl 112 being slightly chamfered on its outside. The actuating lever 104 is shaped such that when the ink cartridge 100 is located in the cartridge receptacle, the actuating lever is pivoted into the locking position by gravity.

If the ink cartridge 100 is inserted into the cartridge receptacle 12, the edge 58 of the cartridge receptacle 12 comes into contact with the chamfered pawl 112 and pivots the actuating lever 104, counter to gravity, into a release position, in which the pawl 112 slides along the inside of the cartridge receptacle 12 past the edge 58, until the pawl 112, under the influence of gravity, comes into engagement with the locking opening 59 embodied on the cartridge receptacle 12, or in other words is located in its locking position, which is equivalent to a stable position of equilibrium.

To remove the ink cartridge 100, the user need merely actuate the actuating lever 104 counter to the influence of gravity and move the pawl 112 out of its locking position into its release position, or unlocking position. The user can then remove the ink cartridge 100 from the cartridge receptacle 12 without problems.

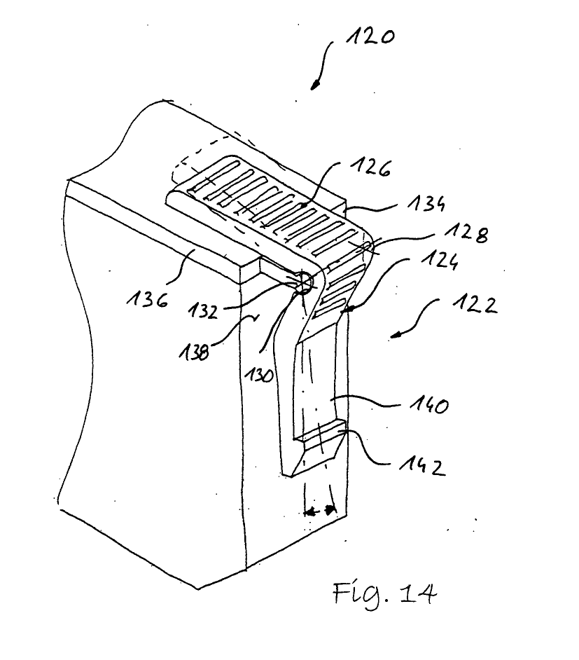

In FIG. 14, an eighth exemplary embodiment of an ink cartridge 120 of the invention is shown. This ink cartridge 120 once again substantially corresponds in structure to the ink cartridge 10 shown in FIGS. 1 through 4 and differs from it only in terms of its locking device 122. Hence in this fifth exemplary embodiment, a rocker 124 is used as the locking device 122. The rocker 124 has an actuating lever 126, which merges with an angled bearing portion 128. A bearing groove 130 extending transversely to the rocker 124 is embodied on the inside of the bearing portion 128, and with this groove, the rocker 124 is pivotably supported, as indicated by the arrow in FIG. 8, on a hinge strip 132 that extends transversely to the introduction plane E of the ink cartridge 120. The hinge strip 120 extends approximately perpendicularly from the side edge 134 of the cap 136 of the ink cartridge 120 and protrudes past the side wall 138 of the ink cartridge 120.

The bearing portion 128 is adjoined by a detent lever 140, which extends approximately perpendicularly to the actuating lever 126 and has a pawl 142 on its free end. Once again, by suitable design of the locking device 122—for instance by sufficiently large dimensioning of the actuating lever 126 in comparison to the detent lever 140—it is attained that the locking device, under the influence of gravity, automatically assumes the locking position, which is equivalent to a stable position of equilibrium.

For insertion, the ink cartridge 120 is inserted in a known way into the cartridge receptacle 12; in the final introduction phase, the edge 58 of the cartridge receptacle 12 comes into contact with the pawl 142, which is chamfered on its outside, and presses the rocker 124 out of its stable position of equilibrium into a release position, in which the pawl 142 slides along the inside of the cartridge receptacle until the pawl 142, under the influence of gravity, snaps into the locking opening 59 provided on the cartridge receptacle 12.

To remove the ink cartridge 120, the actuating lever 126 need merely be raised counter to gravity far enough that the pawl 142 comes out of engagement with the locking opening 59. The ink cartridge 120 can then be removed from the cartridge receptacle 12.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

1. An ink cartridge for insertion into a cartridge receptacle of an inkjet printer, comprising:
a housing, in which there is at least one ink storage chamber,
at least one connection neck provided on the underside of the housing for connecting the ink storage chamber with a supply connection, provided on the inkjet printer, for insertion of the ink cartridge into the cartridge receptacle, and
a locking snap member, elastically prestressed into a locking position, which protrudes from the outside of a side wall of the housing adjoining the underside, and on which locking snap member a detent edge is embodied, with which the locking snap member can be locked with a locking opening, provided on the cartridge receptacle, in its locking position for locking the ink cartridge in the cartridge receptacle,
wherein the locking snap member has a hinged portion, which has a pivot axis which extends approximately parallel to the introduction plane (E) of the ink cartridge, in which plane the ink cartridge is to be inserted into the cartridge receptacle; and wherein the hinged portion is adjoined by a detent portion, on which the detent edge is embodied extending transversely to the introduction plane (E).

2. The ink cartridge of claim 1, wherein the detent portion extends in angled fashion relative to the introduction plane (E) at a predetermined angle (α), which is preferably between 55° and 65°.

3. The ink cartridge of claim 1, wherein the side edge of the detent portion, which edge points in the direction of the underside of the housing, extends in curved fashion and merges with the detent edge.

4. The ink cartridge of claim 1, wherein the detent portion is made from the same material as the hinged portion and essentially has a material thickness from two to three times greater than the hinged portion.

5. An ink cartridge for insertion into a cartridge receptacle of an inkjet printer, comprising:
a housing, in which there is at least one ink storage chamber,
at least one connection neck provided on the underside of the housing for connecting the ink storage chamber with a supply connection, provided on the inkjet printer, for insertion of the ink cartridge into the cartridge receptacle, and
a locking device on the outside of a side wall of the housing adjoining the underside, wherein the locking device has a locking element, with which the locking device can be brought into engagement with a locking opening, provided on the cartridge receptacle, for securing the ink cartridge in the cartridge receptacle,
wherein the locking device has a tilt lever which is L-shaped in longitudinal section, with a detent portion and an actuation portion protruding approximately perpendicularly from the detent portion, and the tilt lever is pivotably connected to the side wall of the housing by a film hinge such that the tilt lever, upon insertion of the ink cartridge into the cartridge receptacle, pivots into its locking position by action of the cartridge receptacle, in which position the actuation portion extends approximately parallel to the side wall of the housing, while the detent portion is in engagement with the locking opening on the cartridge receptacle.

6. The ink cartridge for insertion into a cartridge receptacle of an inkjet printer of claim 5, wherein the ink cartridge can be leveraged out of the cartridge receptacle by pressing the locking device back in the direction of a resting or release position.

7. The ink cartridge of claim 1, wherein means for limiting a deflectability of the locking snap member are provided.

8. An ink cartridge for insertion into a cartridge receptacle of an inkjet printer, comprising:
a housing, in which there is at least one ink storage chamber,
at least one connection neck provided on the underside of the housing for connecting the ink storage chamber with a supply connection, provided on the inkjet printer, for insertion of the ink cartridge into the cartridge receptacle, and
a locking device on the outside of a side wall of the housing adjoining the underside, wherein the locking device has a locking element, with which the locking device can be brought into engagement with a locking opening, provided on the cartridge receptacle, for securing the ink cartridge in the cartridge receptacle,
wherein the locking device is a locking element, embodied separately from the housing, and has a detent element to be actuated by the locking element, and at least the locking element, in a receptacle, embodied on the side wall of the housing, is held adjustably between a release position, in which the ink cartridge can be removed from the cartridge receptacle, and a locking position, in which the locking element keeps the detent element in engagement with the locking opening.

9. The ink cartridge of claim 8, wherein a substantially hollow-cylindrical receptacle is formed perpendicularly, integrally onto the side wall of the housing and is closed by this side wall on the housing side, and in the receptacle a ball acts as the detent element, which is prestressed into the locking position by a compression spring, as the locking element, disposed between the detent element and the side wall.

10. The ink cartridge of claim 8, wherein the receptacle is embodied as a pivot bearing, on which the locking element, embodied as a cylindrical rotary locking bar, is supported rotatably about an axis of rotation extending approximately parallel to the introduction plane (E) of the ink cartridge in which the ink cartridge is to be inserted into the cartridge receptacle; and wherein on the jacket face of the cylindrical rotary locking bar, a spirally extending detent edge is embodied as the detent element, which after the insertion of the ink cartridge can be brought into or out of engagement with the locking opening in the cartridge receptacle by rotation of the rotary locking bar about the axis of rotation.

11. The ink cartridge of claim 8, wherein a channel is embodied as a receptacle on the side wall and on its side remote from the side wall has an opening, into which a detent hook, embodied integrally with the channel wall, protrudes, which hook, in its unlocking position, protrudes with its back side into the channel and on its front side, remote from the channel has a pawl as a detent element; and wherein a wedge can be introduced as a locking element into the channel, with which wedge the detent hook is movable into its locking position, in which the pawl is in engagement with the locking opening in the cartridge receptacle and is retained therein.

12. The ink cartridge of claim 8, wherein as the receptacle, a pocket is embodied on the side wall, and on its face end pointing in the direction of the top side or cap of the ink cartridge and on its open side of the ink cartridge, opposite the side wall, is optionally partly closed; and wherein as the locking element, an elastic snap of essentially U-shaped cross section can be introduced into the pocket, and the U-shaped snap member has at least one first leg for bracing against the side wall of the ink cartridge and at least one second leg, on whose free end a detent edge is embodied as a detent element, which can be brought into engagement with the locking opening in the cartridge receptacle.

13. The ink cartridge of claim 8, wherein the locking element is shaped such that when the ink cartridge has been inserted into the cartridge receptacle, it pivots automatically by gravity into the locking position.

14. The ink cartridge of claim 1, wherein first positioning means are provided on the ink cartridge, which means, upon insertion of the ink cartridge into the cartridge receptacle, cooperate with second positioning means, provided on the cartridge receptacle.

15. The ink cartridge of claim 2, wherein the side edge of the detent portion, which edge points in the direction of the underside of the housing, extends in curved fashion and merges with the detent edge.

16. The ink cartridge of claim 15, wherein the detent portion is made from the same material as the hinged portion and essentially has a material thickness from two to three times greater than the hinged portion.

17. The ink cartridge of claim 16, wherein means for limiting a deflectability of the locking snap member are provided.

18. The ink cartridge of claim 6, wherein means for limiting a deflectability of the locking device are provided.

19. The ink cartridge of claim 5, wherein first positioning means are provided on the ink cartridge, which means, upon insertion of the ink cartridge into the cartridge receptacle, cooperate with second positioning means, provided on the cartridge receptacle.

20. The ink cartridge of claim 8, wherein first positioning means are provided on the ink cartridge, which means, upon insertion of the ink cartridge into the cartridge receptacle, cooperate with second positioning means, provided on the cartridge receptacle.
